(19) United States
(12) Patent Application Publication
(10) Pub. No.: US 2019/0202116 A1
(43) Pub. Date: Jul. 4, 2019

(54) ACOUSTIC ENERGY ENABLED PROPERTY ISOTROPY IN EXTRUSION-BASED 3D PRINTED MATERIALS

(71) Applicant: University of Louisville Research Foundation, Inc., Louisville, KY (US)

(72) Inventor: Keng Hsu, Louisville, KY (US)

(73) Assignee: University of Louisville Research Foundation, Inc., Louisville, KY (US)

(21) Appl. No.: 16/221,125

(22) Filed: Dec. 14, 2018

Related U.S. Application Data
(60) Provisional application No. 62/612,183, filed on Dec. 29, 2017.

(51) Int. Cl. B29C 64/20; B33Y 10/00; B33Y 30/00; B29C 64/118; B29C 64/209

(52) U.S. Cl. CPC B29C 64/20; B33Y 10/00; B29C 64/209; B29C 64/118; B33Y 30/00

(57) ABSTRACT

A system for producing a three-dimensional structure comprises a print head that is movable in one or more dimension and is configured to extrude a polymer melt for subsequently forming each layer of the three-dimensional structure, the polymer melt being formed from a filament; and an ultrasound generating device comprising a piezoelectric transducer and a horn coupled to the print head, the ultrasound generating device being configured to transmit acoustic energy to the print head to provide enhanced interlayer bonding between adjacent deposited layers of the three-dimensional structure.

### TECHNICAL FIELD

The subject matter disclosed herein relates to systems and methods for additive manufacturing techniques. In particular, the presently disclosed subject matter relates to systems and methods for increasing interlayer bonding strength to promote isotropy within structures manufactured by an additive manufacturing process.

### BACKGROUND

There is a need to improve upon additive manufacturing techniques for production purposes. Additive manufacturing, such as through fused filament fabrication (FFF) is used for prototyping of parts and tools. However, improvements are needed if such a technique is to be used for manufacturing processes and production.

Fused Filament Fabrication (FFF) technology represents a capable, flexible, and cost-effective option in the additive manufacturing industry. In FFF, a thermoplastic filament is fed into a heated chamber maintained above the filament's glass transition temperature or melting temperature (for amorphous or crystalline and semi-crystalline polymers respectively). The polymer melt is then pushed through a nozzle typically between 0.2 mm-0.5 mm for a direct write approach to fill in the area within a contour defined by one layer of a 3D object sliced in the build direction. Layer by layer, the desired 3D object is constructed. Though currently a widely adopted prototyping tool, for the FFF process to evolve into a manufacturing tool, and be widely adopted into production of engineering products, its process and material characteristics such as tolerance and accuracy, surface finish, as well as material property uniformity need to reach high level of maturity.

Specific to material property uniformity, the tensile strength of structures manufactured by FFF additive manufacturing techniques in the build direction (e.g., z-direction) typically falls within the range of about 10-65% of the strength of the filaments in the build plane directions (e.g., x-, y-directions), the variability within the range depending on process conditions and materials used. Unlike the strength in the build plane directions, which can be optimized by infill and raster strategy, the inter-layer strength of FFF part is governed by thermal history-dependent mass transfer across layers as well as rheology-dependent microstructures of printed tracks or “roads.” The polymer chains on two sides of an interface go through three stages of wetting, diffusion, and randomization before the interface between two layers of polymer “heals” and the mechanical property in the interlayer direction reaches near that in the build plane direction in which the individual tracks are arranged. If this full healing between adjacent layers across an interface occurs, the mechanical strength properties can approach being considered isotropic, or uniform in any direction. The rheology-dependent microstructure effects also play a key role in interface healing, in that the microstructure of polymers adjacent the interface has a strong effect on the diffusivity of the polymer across the interface. The correlation between the interfacial adhesion strength and the mass transfer and microstructure of polymer can be described by the following equation:

$$\frac{{σ}_{t}}{{σ}_{max}} = {( \frac{{τ}_{weld}}{{τ}_{rep}} )}^{1 / 4} = {( \frac{{τ}_{weld} {D}_{s}}{{R}_{g}^{2}} )}^{1 / 4}$$

In this equation, σₜ, σₘₐₓ represent the strength of the interface and the tensile strength of the material, respectively, τ_{weld} is the healing time of the interface (e.g., the time in which the interface stays above glass transition or melting temperature), τᵣₑₚ is the reptation time, Dₛ is the center of mass diffusivity of polymer chains, and R_{g} is the radius of gyration of polymer chains. The radius of gyration describes how stretched the polymer chains become as the polymer goes through two required steps of changes in the flow: the reduction of flow diameter from of that of the feedstock to the size of the nozzle opening, and the overall 90-degree turn the polymer flow makes as it exists the nozzle and is deposited as the printed track of the structure. The radius of gyration describes the microstructure of polymer near interfaces which plays a key role in what the local diffusivity is as well. Although increasing time during which the interface stays above critical temperature can improve the healing process, increasing diffusivity provides similar effects of improving interface healing.

Several techniques have been demonstrated to effectively improve the interlayer bond strength in FFF printed materials by introducing additional heating to the interfaces, either as a post-fabrication process, or an in-process technique. The objective in these techniques is to increase mass transfer across the interface by increasing the temperature dependent diffusivity. Additives to the surface of filaments have also been used, which can then be used as localized energy coupling sources for local heat generation to promote polymer diffusion across the interface regions between the filament layers. Infrared heating and laser heating have also been used to introduce additional heat to the printed surface immediately prior to deposition of a current layer to increase interface temperature and, therefore, interlayer adhesion. From the same correlation, it is also evident that reducing the radius of gyration of polymer chains could also result in similar improvement in inter-layer strength. This increase can be achieved by promoting relaxation from stretched polymer chains in the printed tracks. As such, given the deficiencies associated with the techniques discussed hereinabove, a need exists for further techniques to further enhance mechanical strength isotropy of structures created via additive manufacturing techniques.

### SUMMARY

One of the fundamental problems regarding conventional FFF additive manufacturing techniques relates to mechanical property anisotropy, where the strength of FFF-3D printing part in the build direction (e.g., z-direction) is significantly lower than that in the build plane directions (e.g., x-, y-directions. The physical phenomenon that governs this issue is the coupled effect of macroscopic thermo-mechanical issues associated with thermal history of the interface, and the microscopic effect of polymer microstructure and mass transfer between layers at interface regions therebetween. A technique of using ultrasonic vibrations as an in-process method to reduce the chain-to-chain secondary interaction and allow more relaxation and diffusion of polymer chains across the interface region to improve interfacial adhesion strength is disclosed herein. This effective technique has the potential to produce FFF manufactured structures with isotropic mechanical properties. The disclosure herein shows that the use of ultrasonic vibrations during FFF-3D printing improves interlayer adhesion in materials printed in identical thermal conditions to those produced via conventional FFF printing techniques. This increase in the interlayer adhesion strength is attributed to the increase in polymer reptation due to ultrasonic vibration-induced relaxation of polymer chains from secondary interactions.

In an example embodiment, a system for producing a three-dimensional structure is provided. Such a system comprises: a print head that is movable in one or more dimension and is configured to extrude a polymer melt for subsequently forming each layer of the three-dimensional structure, the polymer melt being formed from a filament; and an ultrasound generating device comprising a piezoelectric transducer and a horn coupled to the print head, the ultrasound generating device being configured to transmit acoustic energy to the print head to provide enhanced interlayer bonding between adjacent deposited layers of the three-dimensional structure. In some embodiments of the system, the polymer melt comprises polymeric chains.

In some embodiments of the system, the acoustic energy enhances diffusion of the polymeric chains across an interface between the adjacent deposited layers of the three-dimensional structure. In some embodiments of the system, the polymeric chains are cut by the acoustic energy to form shortened polymeric chains, thereby further enhancing diffusion of the shortened polymeric chains across the interface. In some embodiments of the system, the polymer melt is configured to transmit the acoustic energy to an interface region between adjacent deposited layers of the three-dimensional structure. In some embodiments of the system, the ultrasound generating device is arranged along a longitudinal axis of the print head. In some embodiments of the system, the acoustic energy is configured to generate an oscillatory movement of the print head in a direction substantially parallel to the longitudinal axis. In some embodiments of the system, the ultrasound generating device is arranged transverse to a longitudinal axis of the print head. In some embodiments of the system, the ultrasound generating device is configured to generate an oscillatory movement of the print head in a direction substantially orthogonal to the longitudinal axis. In some embodiments of the system, the ultrasound generating device is connected to the print head by a connecting rod that spaces the horn of the ultrasound generating device apart from the print head. In some embodiments of the system, the connecting rod is configured as the horn that is configured to transmit the acoustic energy to the print head.

In another example embodiment, a method of increasing interlayer strength in a three-dimensional structure produced by additive manufacturing is provided. Such a method comprises: feeding a filament into a print head of a 3D printing assembly to produce a polymer melt; extruding a first layer of the three-dimensional structure; extruding a second layer of the three-dimensional structure on top of at least a portion of the first layer; coupling an ultrasound generating device, comprising a piezoelectric transducer and a horn, to the print head; and transmitting acoustic energy from the ultrasound generating device to the print head to induce acoustic pressure waves in the polymer melt to provide enhanced interlayer bonding between the first and second layers of the three-dimensional structure.

In some embodiments of the system, the polymer melt comprises polymeric chains. In some embodiments of the system, transmitting acoustic energy to the print head enhances diffusion of the polymeric chains across an interface between the adjacent deposited layers of the three-dimensional structure. In some embodiments, the method comprises cutting, using the acoustic energy, the polymeric chains to form shortened polymeric chains, thereby further enhancing diffusion of the shortened polymeric chains across the interface. In some embodiments, the method comprises transmitting, via the polymer melt, the acoustic energy to an interface region between the first and second layers of the three-dimensional structure. In some embodiments of the system, the ultrasound generating device is arranged along a longitudinal axis of the print head. In some embodiments of the system, the acoustic energy generates an oscillatory movement of the print head in a direction substantially parallel to the longitudinal axis. In some embodiments of the system, the ultrasound generating device is arranged transverse to a longitudinal axis of the print head. In some embodiments of the system, the ultrasound generating device generates an oscillatory movement of the print head in a direction substantially orthogonal to the longitudinal axis. In some embodiments of the system, the ultrasound generating device is connected to the print head by a connecting rod that spaces the ultrasound generating device apart from the print head. In some embodiments of the system, the connecting rod acts as the horn that transmits the acoustic energy to the print head.

### BRIEF DESCRIPTION OF THE DRAWINGS

FIG. 1 is a schematic view of a system for creating a structure through an additive manufacturing technique, in accordance with the disclosure herein.

FIG. 2 is a side view of an example first embodiment of a device for use in an additive manufacturing system to promote inter-layer bonding in structures produced using additive manufacturing techniques, in accordance with the disclosure herein.

FIG. 3 is a side view of an example second embodiment of a device for use in an additive manufacturing system to promote inter-layer bonding in structures produced using additive manufacturing techniques, in accordance with the disclosure herein.

FIG. 4 is a side view of the device of FIG. 2 dispensing a layer of material from a filament over a substrate, in accordance with the disclosure herein.

FIG. 5 is a side view of the device of FIG. 2 dispensing a layer of material over a previously applied layer of material, in accordance with the disclosure herein

FIG. 6 is a partial side view of the device of either of FIG. 1 or 2 dispensing a layer of material over a substrate, in accordance with the disclosure herein.

FIGS. 7A and 7B are cross-sectional views showing that the layer of material being dispensed can have a varying width, in accordance with the disclosure herein.

FIGS. 8A and 8B show the resulting scission in the polymeric molecular chains within the filament caused by application of ultrasound energy, in accordance with the disclosure herein.

FIG. 9 is a graphical plot showing the effect of the cross-sectional geometry of the layer being dispensed on interlayer adhesion, as well as the effect of ultrasound application in improving interlayer bond strength, in accordance with the disclosure herein.

FIG. 10 is a graphical plot showing empirical results of interlayer tensile strength of structures that were created by applying ultrasound energy to a filament during an additive manufacturing process.

FIG. 11 is a further example side view of the embodiment shown in FIG. 2, in accordance with the disclosure herein.

FIG. 12 is a further example side view of the embodiment shown in FIG. 5, in accordance with the disclosure herein.

FIG. 13 is a schematic side view of a structure generated via an additive manufacturing process to empirically test the interlayer strength of additively manufactured structures, in accordance with the disclosure herein.

### DETAILED DESCRIPTION

For FFF part material property uniformity, existing literature has placed significant emphasis on optimization of FFF process inputs, such as extruder temperature, raster strategy, layer height, reducing air gaps between FFF filament roads, and investigating the effects of such process inputs on the mechanical characteristics of built parts. The consensus is that, through the optimization of process inputs, the overall characteristics of FFF built parts can be optimized, yet while some properties are enhanced, other properties may suffer some amount of degradation. For example, overall strength of the part can be obtained by increasing overlaps in filament roads in each layer. Doing so, however, results in poor dimensional tolerances and surface finish.

In the aspect of material property uniformity specifically, the tensile strengths of as-built FFF parts in the inter-filament/-layer directions falls in the range of 10%-65% of that in the coaxial direction of the filaments (i.e., along its length). Unlike the strength in the direction parallel to the layers, which can be optimized by infill and raster strategy, the inter-layer strength of FFF parts is governed by temperature and time-dependent diffusion and intermingling of polymer chains across the interfaces between layers. The inter-layer bond formation process is essentially governed by the polymer interface healing process. During this healing process, polymer chains on both sides of an interface (e.g., in the deposited layer and the layer on which the deposited layer is dispensed) go through three stages of wetting, diffusion, and randomization before the interface between the two domains of polymer disappears and the interface is “healed.” When this occurs in the inter-layer interfaces in a FFF printed part, the mechanical property in the interlayer direction (e.g., orthogonal to the direction along the length of extension of the filament) reaches near that in the direction of the filaments, and the part property becomes isotropic or uniform in any given direction, disregarding the effects of air gaps in between filaments. As such, the fact that the interface healing process governs the strength uniformity in FFF parts represents an opportunity to achieve high strength isotropy in additively manufactured structures by introducing process modifications independent of the native FFF process parameters promote enhanced healing at the interfaces in a structure produced by FFF additive manufacturing. Particularly, if these process modifications are carried out in real-time during FFF instead of a pre-process or a post-process that takes place before or after the part fabrication, the capabilities of the FFF-based 3D printing approach can be greatly enhanced.

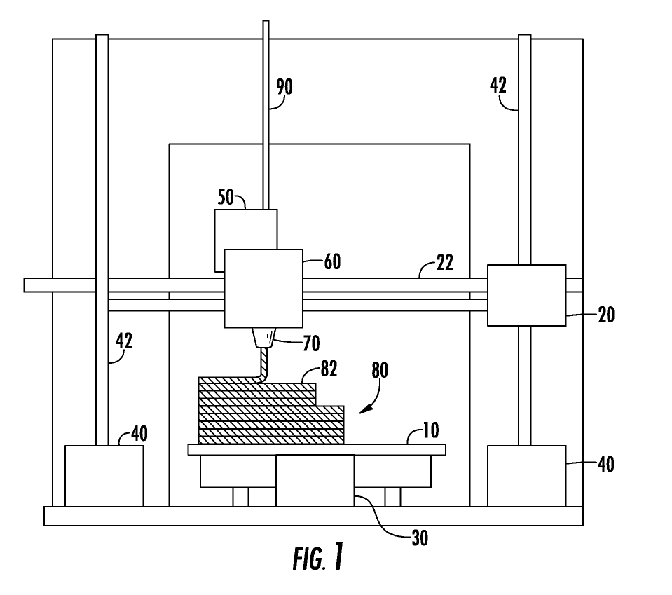

In FIG. 1, an example embodiment of a system for additive manufacturing is disclosed. A platform 10 is provided, on which a structure, generally designated 80, is produced by successively depositing individual layers 82 on top of each other to additively manufacture the structure 80. The layers are formed by extruding a polymer melt, which is formed from a filament 90, from a print head 70. The filament 90 is input or drawn into an extruder motor 50 that is movable in one or more directions (e.g., x, y, and z directions) along a trolley 60. Trolley 60 is movable by an x-axis motor 20 along an x-axis support rod 22 and by two z-axis motors 40 along respective z-axis support rods 42. In the embodiment shown, the platform 10 is movable in the y-direction by a y-axis motor 30, such that the print head 70 is movable in three dimensions relative to the platform 10. In some embodiments, the platform 10 is stationary and the print head is mobile in three dimensions. In other embodiments, the print head 70 is stationary and the platform is mobile in three dimensions.

In another aspect, a non-thermal method of increasing interlayer strength in additively manufactured structures and, therefore, increasing the isotropy of such additively manufactured structures is provided herein. The method comprises applying acoustic energy (e.g., in the form of oscillatory displacement of the print head of an additive manufacturing system) to induce acoustic pressure waves in the polymer melt. It is contemplated that it is particularly advantageous to apply the disclosed method to Fused Filament Fabrication (FFF) additive manufacturing techniques. More specifically, the invention utilizes pressure waves that are formed in the extruded polymer melt to enhance the mass transfer via polymer chain reptation across interfaces formed during deposition. In one aspect, the pressure waves formed in the polymer melt are the result of an ultrasound generating device, comprising a transducer and a horn, that is mounted to the print head. In some embodiments, the transducer is a piezoelectric transducer that is energized by an AC electrical excitation signal to cause expansion and contraction movements that are transmitted, via the horn, to the print head. In one embodiment, the piezoelectric transducer and horn are attached directly to the print head to cause oscillatory displacement of the print head and to introduce the acoustic energy and resulting acoustic pressure waves in the polymer melt. By controlling the frequency and amplitude of the input AC excitation signal, the frequency and amplitude in the vibrating piezoelectric transducer and, therefore, in the print nozzle, can also be controlled. In accordance with embodiments of the invention, excitation frequencies for the piezoelectric transducer might be within, and including, the range of 1000 Hertz (Hz) to 150,000 Hz. The oscillatory displacement in the print head by the excitation of the piezoelectric transducer might be within, and including, the range of 1 micrometer (pm) to 100 μm. The oscillatory movements of the print head allow the coupling of acoustic energy into the polymer melt as it is being extruded from a nozzle of the print head to form a “road” (e.g., an individual layer of a structure created by additive manufacturing) during an FFF manufacturing process. As such, the system is configured to use acoustic energy in the form of oscillatory displacement in the print head to induce acoustic pressure waves in the polymer melt used in FFF and Fused Filament Deposition (FFD) modeling for additive manufacturing for the purposes of improving print quality.

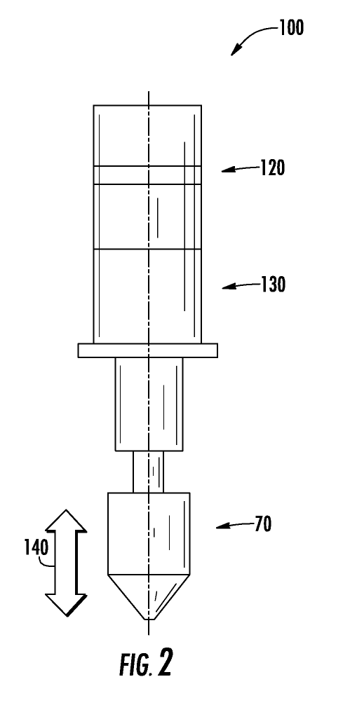

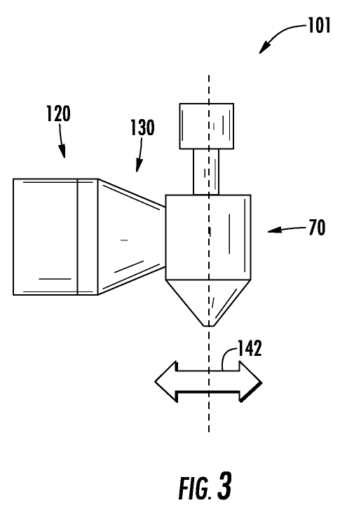

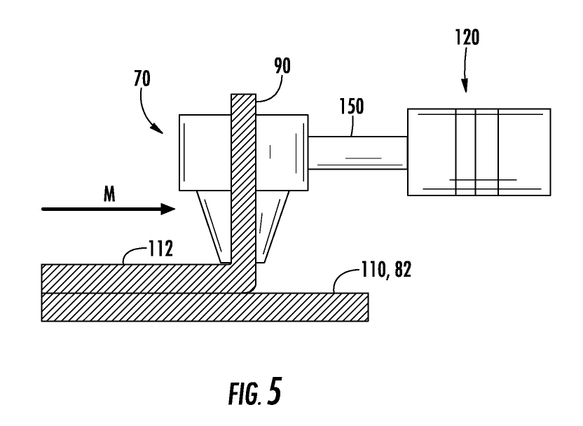

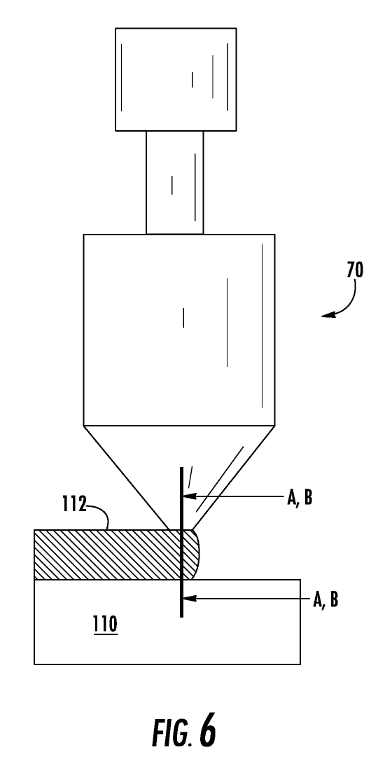

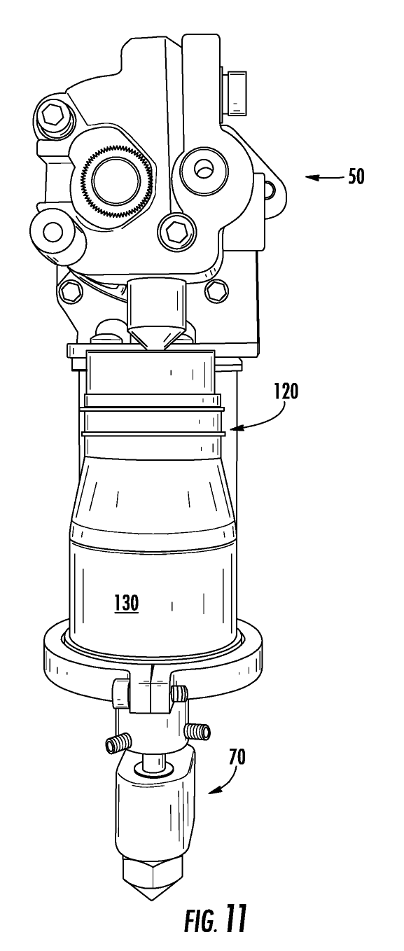

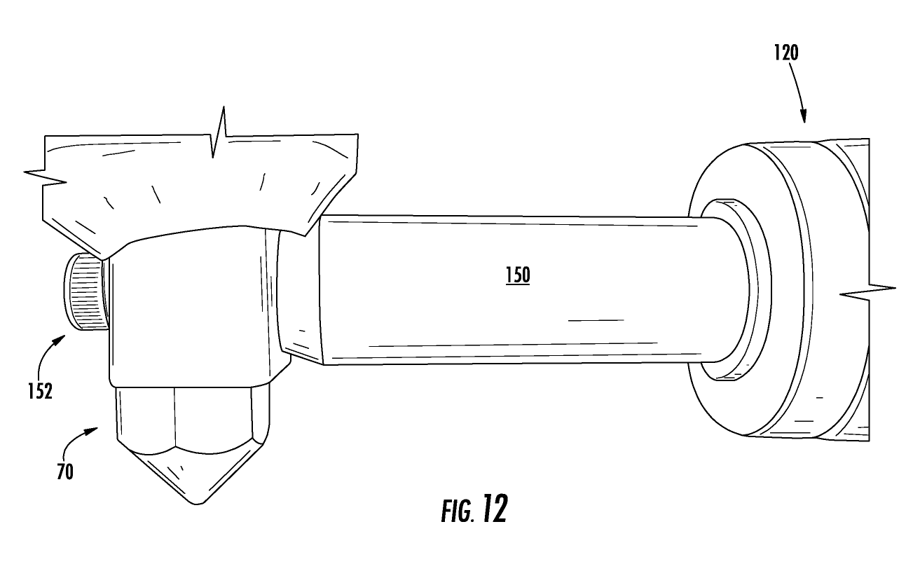

Referring to FIGS. 2-7B, 11, and 12, example embodiments of a device for use in the system of FIG. 1 are shown. The embodiments shown in FIGS. 3-5 and 12 show a transverse mode arrangement of an ultrasound generating device relative to the print head 70, which moves in the direction designated by arrow M. The transverse-mode implementation of this method in a system, generally designated 101, couples vibrations produced by a transducer 120, via a horn 130, to the print head 70 to cause a vibration of the print head. The vibration of the print head 70 is in a direction 142 substantially orthogonal to the flow of the polymers through the nozzle formed at the end of the print head 70 form which the polymer melt is dispensed/extruded. In some embodiments, as shown in FIGS. 5 and 12, the transducer 120 and/or the horn 130 are spaced apart from and connected to the print head 70 by a connecting rod 150, which can be advantageous by reducing heat transfer from the print head 70 to the transducer 120. The embodiments of FIGS. 2 and 11 show a longitudinal mode arrangement of the ultrasound generating device relative to the print head 70. In the longitudinal mode embodiment, the system, generally designated 100, comprises a print head 70 that is vibrated in a direction 140 that is substantially parallel to the direction in which the flow of the polymer melt through the nozzle. Regardless of the particular embodiment, the vibrations of the print head 70 induces movements of and within the polymer melt as and after it exits from the print head 70. The movements of the print head 70 further generate pressure waves within the polymer melt that waves propagate, via the polymer melt, as pressure waves that travel through the molten part of the polymer melt and enhances the mass transfer across the solid-molten polymer interfaces within the structure being assembled. As a result of this increased vibration of the polymer melt at the interface between the layer of the structure being formed and previously dispensed layers, the strength of the structure formed by the “healing” of the polymer melt at these internal interfaces increases because of the increased mass transfer (e.g., intermixing) across them. Accordingly, the overall strength of the part in the build direction (e.g., orthogonal to the plane in which the layer is being deposited) is increased and can even achieve substantially the same strength as the strength of the raw material itself.

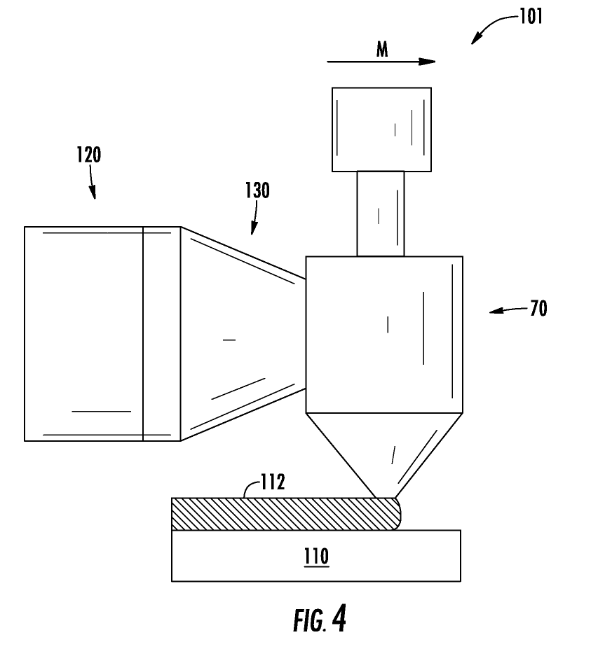

In the example embodiments shown in FIGS. 2-5, 11, and 12, structures are generated by using an additive manufacturing technique, specifically using a gantry-style 3D printer that is modified to transfer ultrasound vibrations into the polymer melt extruded from the nozzle of the print head 70. As shown in FIG. 4, the dispensed layer 112 can be dispensed over a substrate 110. As shown in FIG. 5, the dispensed layer 112 can be dispensed over a substrate 110 or a previously deposited layer 82 of a structure, as shown in FIG. 1.

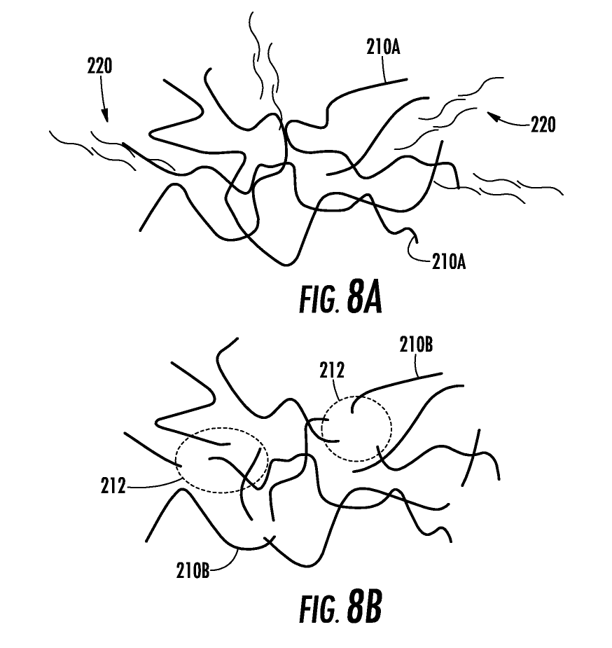

As shown in FIG. 8A, ultrasound waves at sufficiently high power levels, generally designated 220, are applied to polymeric chains 210A, producing polymer scission, as shown in FIG. 8B at regions 212. Due to this polymer scission, the polymeric chains 210A are cut or broken to produce a larger number of shortened polymeric chains 210B. Polymeric scission can be advantageous in at least two aspects. In a first aspect, the advantages can be categorized as being geometrically derived. Namely, shorter polymeric chains are less entangled with each other, thereby having a decreased linear density. Similarly, a lower reputation time yields a higher center of mass diffusivity for the polymer chains. In a second aspect, the advantages can be categorized as being kinetic and/or rheologically based. As such, the polymeric scission increases polymer mobility, promoting further disentanglement, and a reduction in viscosity due to the decreased lengths of the shortened polymeric chains 210B.

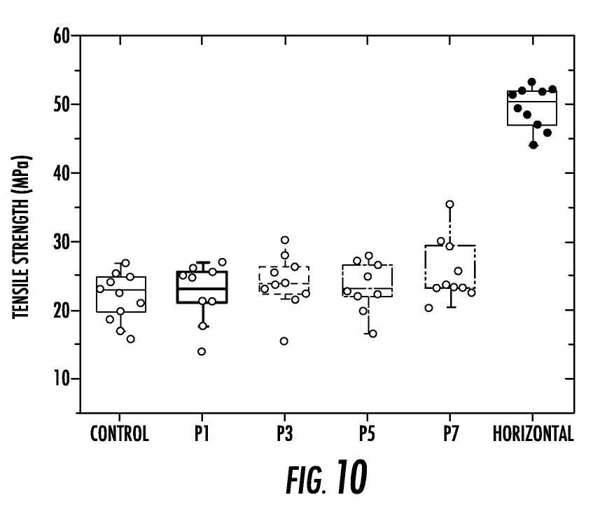

In an example embodiment of the longitudinal mode of the system, shown in FIG. 11, example structures were generated via additive manufacturing and, as shown in FIG. 10, results were plotted to demonstrate the feasibility of the method and system disclosed herein. In the embodiment shown in FIG. 11, a commercially available FFF-type 3D printer was used as a base platform. The print head 70 is modified to include a piezoelectric transducer, generally designated 120, a vibration amplification horn, generally designated 130, and a high-frequency AC signal generator operatively connected to drive oscillatory movements of the piezoelectric transducer 120. The print head 70 is mechanically coupled onto the effector end of the horn 130, opposite the end of the horn 130 to which the piezoelectric transducer 120 is attached. The horn 130 and the piezoelectric transducer 120 comprise a center through-hole that is designed so that a filament of a supply feedstock can be fed therethrough by a filament drive unit 50. In the example embodiment for which the results are plotted in FIG. 10, the AC frequency is set at 68,000 Hz. Accordingly, the print head 70 oscillates (e.g., vibrates) at about 68,000 time per second while a normal FFF additive manufacturing process occurs.

For the results shown graphically in FIG. 10, standard tensile test coupons were printed with a PLA material. Except for the print orientation of the samples, all print parameters and raster strategy for the assembly were kept the same. The horizontal samples were printed such that the test section was in the horizontal orientation where the printed tracks were along the length direction of the test samples. In the vertical samples, however, the printed tracks were orthogonal to the length of the samples. With this arrangement, when the printed samples were tested, the vertical samples would display a strength property dictated by the inter-layer bond strength. However, the horizontal samples, when tested, would display the inherent strength of the material itself. FIG. 10 shows empirical results of the strengths of printed samples in vertical as well as horizontal orientations as well as vertical samples with and without acoustic energy input during FFF printing. The testing of the vertical samples without acoustic energy input is labeled as the “control” dataset. The increase in the inter-layer strength in samples printed with acoustic energy input is evident from the data plots. The increase is also observed to increase as a function of the increase in the acoustic energy input. As such, within the range of energy applied, a higher input acoustic energy creates a stronger inter-layer bond in the printed vertical samples. For example, referring to FIG. 10, the P7 dataset was generated with the highest intensity of acoustic energy, with P5 being a lower intensity of acoustic energy from P7, P3 being a lower intensity of acoustic energy from P5, and P1 being the lowest intensity of acoustic energy evaluated and plotted in FIG. 10.

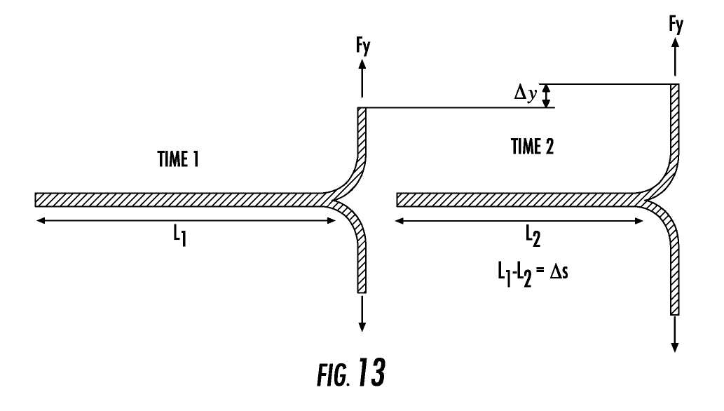

FIG. 13 shows the geometry of specimens that were printed having two single tracks one on top of the other. 1.75 mm-diameter Acrylonitrile Butadiene Styrene (ABS) filament feedstocks and a 0.87 mm-diameter nozzle were used for printing all specimens. Two different temperature settings for extruder/build plate were used at 190° C. 90° C. and 210° C./80° C. at print speeds of 200 mm/min and 500 mm/min respectively. Both top and bottom tracks in a given specimen were printed in the same direction (from +x to −x) in the same length (35 mm). Track heights (h) were varied from 0.15 mm to 0.65 mm, while track widths (b) were varied from 0.63 mm to 1.41 mm. To ensure the bottom (first-layer) track reaches a uniform spatial temperature distribution along its entire length prior to the printing of top layer (second-layer) track, a wait time of ˜70 second was introduced between printing of the two layers by adding a single layer, single line loop around the bottom track. Selection of the 70-second wait time was based on IR thermography where the first layer reaches the build plate temperature. In ultrasound-assisted specimens, the ultrasound was only applied during printing of the top track. The bottom tracks were identical in all specimens within each set. These interlayer adhesion strength of each of these specimens were evaluated empirically using technique A of the ASTM F88 Peel Test. This standard system is typically used to measure adhesive force between two sealed flexible bands. This is an appropriate method of testing adhesion energy in this study since it applies for flexible specimens, allowing for a spatial view of adhesion between two layers (as compared with tensile testing where the measured strength corresponds to the lowest of a series of interfaces).

FIG. 13 schematically shown how this method was implemented. An initial cleft is introduced between the two adhesive layers and pulled in opposite direction at constant rate while the peel force is continuously recorded as the cleft progresses towards the other end. Specific to the study reported here, a small pre-crack or slit between the top and bottom tracks was introduced by applying an adhesion barrier on the end of the first track. Black ink from a permanent marker was used as the adhesion barrier to prevent bond formation with the two layers, and therefore left a small “pre-crack” on the interface. During each trouser peel test, the two free ends of a specimen were mounted on the grippers of a lab-built trouser peel test apparatus. The gripper travel rates were set to 30 mm/min for all specimens, which resulted in a peeling rate of 15 mm/min for all specimens. A 200-Newton capacity load cell was installed on the trouser peel test apparatus to measure peeling force of each specimen. A mechanical lever was used to transfer the peeling force to the load cell. The output from the loadcell was recorded in real-time during each peel test.

As shown in FIG. 13, pulling forces, F_{y}, in the peeling tests are measured using a load cell, and used to calculate the adhesion energy, R, of the interface. Using an energy balance that equates the work input to result in creation of two new surfaces between two tracks and the elastic energy to bend those two tracks into the 90-degree configuration, the measured pulling force is related to the adhesion energy on the interface via the following equation:

F_{y}×Δy=(b×Δs)R+ΔU_{ε}

In this equation, Δy is the displacement in the two vertical sections, b is the track width, Δs is the length of the newly created surface, and ΔU_{ε} is the strain energy associated with the 90-degree bend. This strain energy term is negligible here in that the bend radius is small (as a result of energy required to tear the interface is much larger than that needed to bend the tracks) since the elastic constant is low.

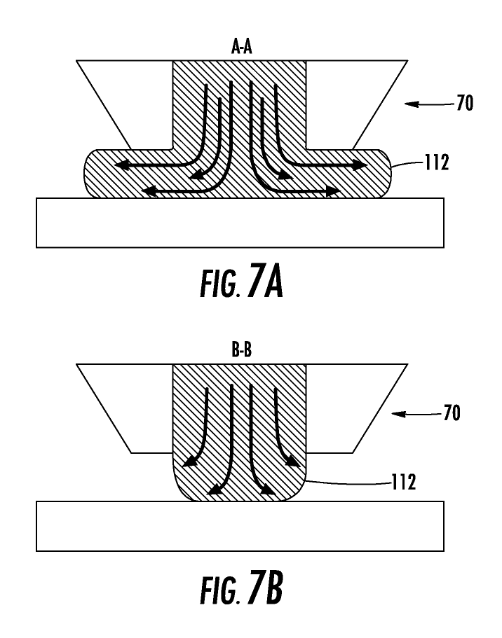

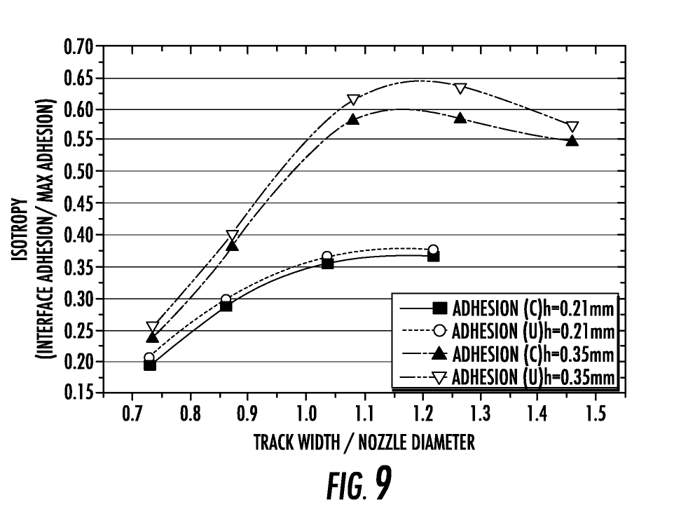

The trouser peel test results shown in FIG. 9 illustrate the improvement in interlayer adhesion due to the application of ultrasound energy. As shown, tracks were evaluated at heights of 0.21 mm and 0.35 mm, with the ratio of the track width to nozzle diameter varying from about 0.7 to greater than 1.0. An example of the ability of the variability of the track width is shown in FIGS. 7A and 7B. In FIG. 7A, the ratio of the track width to nozzle diameter is greater than 1.0. In FIG. 7B, the ratio of the track width to nozzle diameter is approximately 1.0. It is evident that the interfacial adhesion increases, to a certain point, as the track width increases relative to the nozzle diameter, but plateaus after the width of the track exceeds a ratio of around 1.0 of the diameter of the nozzle. As shown, the plateau for the increase in isotropy occurs at different ratios of the track width vs. nozzle diameter, depending on the track height being dispensed. Regardless, the isotropy of the structures created applying ultrasound energy to the polymer melt is uniformly greater than the degree of isotropy created using conventional additive manufacturing techniques. It is contemplated that this plateau phenomenon is caused by changes in the local shear forces experienced by the polymer melt as it transitions from flowing through the cylindrical nozzle to flowing in the horizontal direction along the tracks as it is deposited thereon. It is conceivable that as the track width increases, the overall flow rate and, therefore, flow velocity of polymer increases. This increase in flow velocity in turn increases the local shear stresses experience by the polymer near the top and bottom surfaces of the track and cause increased amount of disentanglement of polymer chains in those regions. This increase in chain alignment (or decrease in entanglement of polymer chains) can increase diffusivity of polymer in the orthogonal directions, resulting in an increase in interlayer adhesion due to increased reptation of polymeric chains across the interface.

The embodiments described herein are examples only and are not limiting. Many variations and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims.

1. A system for producing a three-dimensional structure, the system comprising:
a print head that is movable in one or more dimension and is configured to extrude a polymer melt for subsequently forming each layer of the three-dimensional structure, the polymer melt being formed from a filament; and
an ultrasound generating device comprising a piezoelectric transducer and a horn coupled to the print head, the ultrasound generating device being configured to transmit acoustic energy to the print head to provide enhanced interlayer bonding between adjacent deposited layers of the three-dimensional structure.

2. The system of claim 1, wherein the polymer melt comprises polymeric chains.

3. The system of claim 2, wherein the acoustic energy enhances diffusion of the polymeric chains across an interface between the adjacent deposited layers of the three-dimensional structure.

4. The system of claim 3, wherein the polymeric chains are cut by the acoustic energy to form shortened polymeric chains, thereby further enhancing diffusion of the shortened polymeric chains across the interface.

5. The system of claim 1, wherein the polymer melt is configured to transmit the acoustic energy to an interface region between adjacent deposited layers of the three-dimensional structure.

6. The system of claim 1, wherein the ultrasound generating device is arranged along a longitudinal axis of the print head.

7. The system of claim 6, wherein the acoustic energy is configured to generate an oscillatory movement of the print head in a direction substantially parallel to the longitudinal axis.

8. The system of claim 1, wherein the ultrasound generating device is arranged transverse to a longitudinal axis of the print head.

9. The system of claim 8, wherein the ultrasound generating device is configured to generate an oscillatory movement of the print head in a direction substantially orthogonal to the longitudinal axis.

10. The system of claim 8, wherein the ultrasound generating device is connected to the print head by a connecting rod that spaces the horn of the ultrasound generating device apart from the print head.

11. The system of claim 10, wherein the connecting rod is configured as the horn that is configured to transmit the acoustic energy to the print head.

12. A method of increasing interlayer strength in a three-dimensional structure produced by additive manufacturing, the method comprising:
feeding a filament into a print head of a 3D printing assembly to produce a polymer melt;
extruding a first layer of the three-dimensional structure;
extruding a second layer of the three-dimensional structure on top of at least a portion of the first layer;
coupling an ultrasound generating device, comprising a piezoelectric transducer and a horn, to the print head; and
transmitting acoustic energy from the ultrasound generating device to the print head to induce acoustic pressure waves in the polymer melt to provide enhanced interlayer bonding between the first and second layers of the three-dimensional structure.

13. The method of claim 12, wherein the polymer melt comprises polymeric chains.

14. The method of claim 13, wherein transmitting acoustic energy to the print head enhances diffusion of the polymeric chains across an interface between the adjacent deposited layers of the three-dimensional structure.

15. The method of claim 14, comprising cutting, using the acoustic energy, the polymeric chains to form shortened polymeric chains, thereby further enhancing diffusion of the shortened polymeric chains across the interface.

16. The method of claim 12, comprising transmitting, via the polymer melt, the acoustic energy to an interface region between the first and second layers of the three-dimensional structure.

17. The method of claim 12, wherein the ultrasound generating device is arranged along a longitudinal axis of the print head.

18. The method of claim 17, wherein the acoustic energy generates an oscillatory movement of the print head in a direction substantially parallel to the longitudinal axis.

19. The method of claim 12, wherein the ultrasound generating device is arranged transverse to a longitudinal axis of the print head.

20. The method of claim 19, wherein the ultrasound generating device generates an oscillatory movement of the print head in a direction substantially orthogonal to the longitudinal axis.

21. The method of claim 19, wherein the ultrasound generating device is connected to the print head by a connecting rod that spaces the ultrasound generating device apart from the print head.

22. The method of claim 21, wherein the connecting rod acts as the horn that transmits the acoustic energy to the print head.
